(19) United States
(12) Patent Application Publication
(10) Pub. No.: US 2007/0115623 A1
(43) Pub. Date: May 24, 2007

(54) ELECTRONIC DEVICE

(75) Inventor: YUN-HSIN SHIH, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 11/550,414

(22) Filed: Oct. 18, 2006

(30) Foreign Application Priority Data
Nov. 22, 2005 (TW) 94140911

(51) Int. Cl. G06F 1/16

(52) U.S. Cl. 361/683

(57) ABSTRACT

An electronic device suitable for connecting to a portable storage device is provided. The electronic device includes a main body, a protective cover, a transmission cable and a movable connector. The main body has a display region and an accommodating space. The protective cover connects to the main body and is closed to the accommodating space. The transmission cable is disposed in the main body with one end of the transmission cable connected to the main body. The movable connector is disposed on the other end of the transmission cable. The movable connector is suitable for connecting to the portable storage device and the accommodating space is suitable for hiding the movable connector.

### CROSS-REFERENCE TO RELATED APPLICATION

This application claims the priority benefit of Taiwan application serial no. 94140911, filed on Nov. 22, 2005. All disclosure of the Taiwan application is incorporated herein by reference.

### BACKGROUND OF THE INVENTION

1. Field of the Invention

The present invention relates to an electronic device. More particularly, the present invention relates to an electronic device with built-in transmission cable and connector.

2. Description of the Related Art

With the maturity of data processing techniques, personal computers have become an indispensable device for processing documents, recreation, data transmission and interpersonal communication. However, due to functional considerations, the volume of most personal computers can hardly be miniaturized further improve the portability.

To meet the demands for portability, portable notebook computers have been developed for the convenience of the consumers. Although the notebook computer cannot include all the powerful functions of a personal computer, the slim and compact design of a notebook computer and the provision of all the basic needs demanded by most users render it highly popular on the consumer market.

However, notebook computers are normally expensive. With the consumers constantly looking for a notebook computer having more powerful computing functions, the popularity of notebook computers always fall short that of the personal computers by a big margin. Therefore, most consumers still choose to use a portable storage device such as a USB storage media as a data transmission medium between a person's computer at home and a computer in the company.

In general, the host personal computer has a number of USB sockets. Thus, the USB storage media can electrically connect with the host computer through one of the USB sockets. However, the host computer is normally quite bulky. Therefore, it is normally placed underneath a desk to save space. When a user needs to transmit data between a portable storage device and a personal computer, the user has to bend down and plug the portable storage device into one of the USB sockets on the computer. If the USB socket is located at an awkward location, the plugging the portable storage device into the personal computer will be a hard and inconvenient job.

### SUMMARY OF THE INVENTION

Accordingly, at least one objective of the present invention is to provide an electronic device with a built-in transmission cable and connector to facilitate a user to use a portable storage device.

To achieve these and other advantages and in accordance with the purpose of the invention, as embodied and broadly described herein, the invention provides an electronic device suitable for connecting with a portable storage device. The electronic device includes a main body, a protective cover, a transmission cable and a movable connector. In this electronic device, the main body has a display region and an accommodating space. The protective cover connects to the main body and is closed to the accommodating space for covering the accommodating space. The transmission cable is disposed in the main body with one end of the transmission cable connected to the main body. The movable connector is disposed on the other end of the transmission cable. The movable connector is suitable for connecting to the portable storage device and the accommodating space is suitable for hiding the movable connector.

In one embodiment of the present invention, the protective cover is located at the edge of the main body.

In one embodiment of the present invention, the moveable connector is a USB connector.

In one embodiment of the present invention, the protective cover is hinged to the main body.

In one embodiment of the present invention, the accommodating space is suitable for hiding the portable storage device.

In one embodiment of the present invention, the electronic device further includes a signal line for connecting to a host computer, so that the portable storage device is electrically connected to a host computer through the electronic device and the signal line. Furthermore, the electronic device is a display device.

In one embodiment of the present invention, the electronic device may be a personal digital assistant (PDA), a pocket personal computer (pocket PC) or a tablet PC.

In the preferred embodiment of the present invention, the transmission cable is housed inside the main body of an electronic device. This accommodating space is suitable for placing a moveable connector. When a user needs to connect a portable storage device with the electronic device of the preferred embodiment of the present invention for data access operation, the user only has to pull out the moveable connector from the accommodating space and plug the portable storage device into the moveable connector. Therefore, the portable storage device and the electronic device of the preferred embodiment of the present invention can be assembled together more conveniently.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view of an electronic device according to a first embodiment of the present invention.

FIG. 2 is a locally magnified sectional view of FIG. 1.

FIG. 3 is a view showing the configuration after a user has pulled out a moveable connector from a main body.

FIG. 4 is a view of an electronic device according to a second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

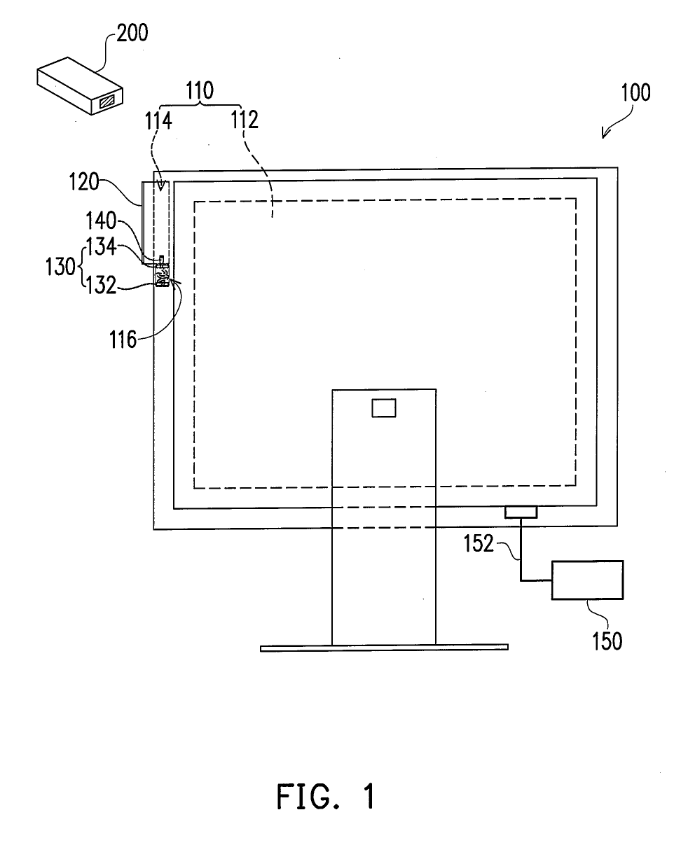

FIG. 1 is a view of a electronic device according to a first embodiment of the present invention. As shown in FIG. 1, the electronic device 100 according to the present embodiment can be connected to a portable storage device 200. The electronic device 100 includes a main body 110, a protective cover 120, a transmission cable 130 and a moveable connector 140.

As shown in FIG. 1, the main body 110 has a display region 112 and an accommodating space 114. In the present embodiment, the main body 110 is a liquid crystal electronic device. In other embodiment, the main body 110 may be a plasma electronic device. However, the main body 110 may be a PDA, a pocket PC, a tablet PC or other portable electronic device whose details is described below. When the main body 110 is a liquid crystal electronic device, the electronic device 100 further includes a signal line 152 for connecting a host computer 150.

The protective cover 120 is joined to the main body 110 and is closed to the accommodating space 114 located on the host computer 150 for covering the accommodating space 114, so that the main body 110 has an aesthetically appealing and uniform appearance. In other words, the protective cover 120 is located at the edge of the main body 110 and is connected to the main body 110 through a hinge. Hence, the user can easy lift the cover 120 and expose the moveable connector 140. In another embodiment, the protective cover 120 can be separated from the main body 110. For example, the user may apply a force to the protective cover 120 and detach the protective cover 120 from the main body 110.

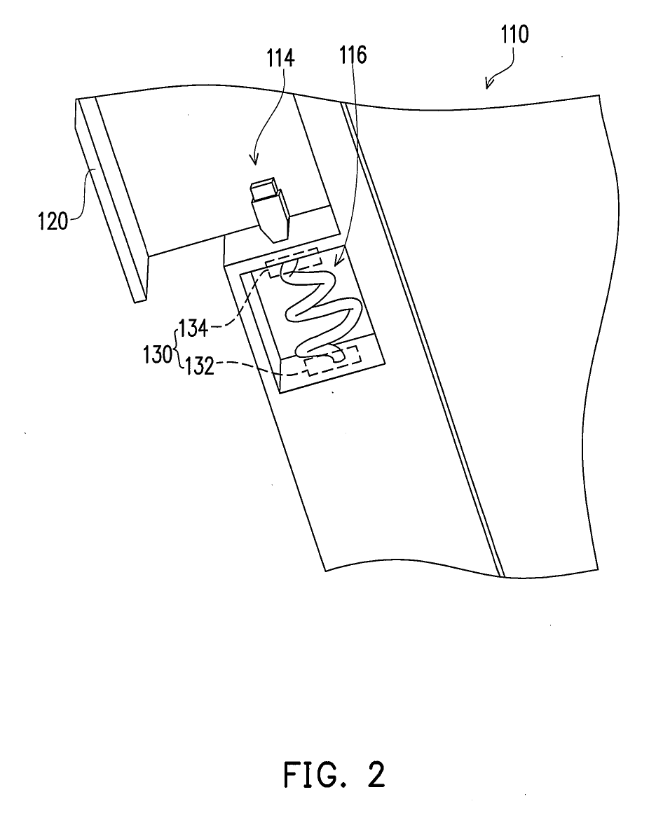

FIG. 2 is a locally magnified sectional view of FIG. 1. As show in FIGS. 1 and 2, the transmission cable 130 is disposed inside the main body 110. Furthermore, one end 132 of the transmission cable 130 is connected to the main body 110 and the other end 134 of the transmission cable 130 is connected to the moveable connector 140. The moveable connector 140 is suitable for connecting with a portable storage device 200. Moreover, the moveable connector 140 is suitable for hiding inside the accommodating space 114. In the present embodiment, the moveable connector 140 is a USB connector, for example.

In the present embodiment, the main body 110 has a compartment 116 ( as shown in FIG. 2) for housing the transmission cable 130. In addition, the transmission cable 130 has a diameter of about 3.5 mm and is fabricated using a harder material. Therefore, when the user is not using the transmission cable 130, the transmission cable 130 can be forced back into the compartment 116. In particular, the data stored inside the portable storage device 200 can be sequentially transmitted to the host computer 150 by way of the moveable connector 140, the transmission cable 130, the main body 110 and the signal line 152. In other words, the signal line 152 not only serves as a data transmission pathway between the main body 110 and the host computer 150, but it also serves as a data transmission pathway between the portable storage device 200 and the host computer 150.

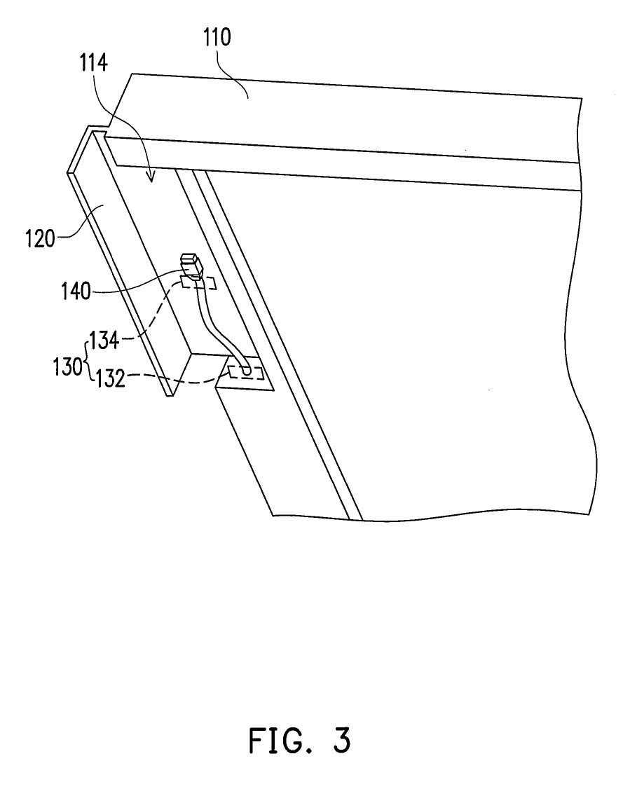

FIG. 3 is a view showing the configuration after a user has pulled out a moveable connector from a main body. As shown in FIGS. 1, 2 and 3, when a user needs to transmit data between the portable storage device 200 and the host computer 150, the user can lift the protective cover 120 at the edge of the main body 110 to expose the moveable connector 140 Then, the user can pull out the moveable connector 140. Thereafter, the moveable connector 140 is connected to the portable storage device 200. When the user pulls out the moveable connector 140, the distance that the moveable connector 140 can move depends on the length of the transmission cable 130 as one end 134 of the transmission cable 130 is connected to the moveable connector 140. In other words, part of the transmission cable 130 (as shown in FIG. 3) will be exposed as the moveable connector 140 is moved.

In particular, the accommodating space 114 in the main body 110 can be slightly larger or equal to the spatial volume of the portable storage device 200 so that the portable storage device 200 can be disposed inside the accommodating space 114. More specifically, hiding the portable storage device 200 inside the accommodating space 114 can prevent the portable storage device 200 from accidentally getting plugged off. Therefore, a non-interrupted data transmission between the portable storage device 200 and the host computer 150 can be performed.

After detaching the moveable connector 140 from the portable storage device 200, the user may force the transmission cable 130 back into the compartment 116 of the main body 110. In the meantime, the moveable connector 140 is also returned to its original position as shown in FIG. 2.

In the preferred embodiment of the present invention, because the moveable connector is disposed on the main body, for accessing the data stored inside a portable storage device, the user only have to plug the portable storage device into the moveable connector. Hence, an electronic device having this arrangement is able to facilitate a user who needs to access a portable storage device.

Furthermore, because the portable storage device has a variety of dimensions, the deployment of a transmission cable permits a wider range of movement for the moveable connector. In addition, the transmission cable can be hidden inside the main body when it is not used. Ultimately, the user can access the data of a portable storage device quite conveniently.

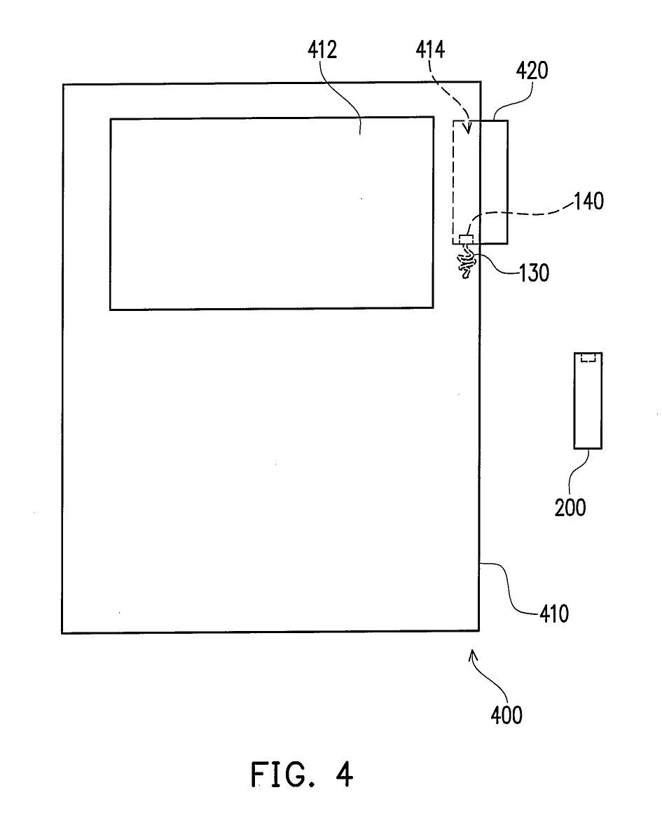

FIG. 4 is a sketch of an electronic device according to a second embodiment of the present invention. As shown in FIG. 4, the electronic device 400 in the present embodiment is a PDA, a pocket PC, a tablet PC or other portable electronic device. Similarly, the main body 410 has a display region 412 and an accommodating space 414.

When a user needs to transfer the data inside a portable storage device 200 to the main body 410 or to transfer the data inside the main body 410 to the portable storage device 200, the user lifts open a protective cover 420, pulls the moveable connector 140 out and connects the moveable connector 140 with the portable storage device 200 together for performing the required data transmission. In addition, the display region 412 can display the progress in the data transmission or the data content transferred from the portable storage device 200 to the main body 410.

At the completion of the data transmission operation, the user only has to unplug the moveable connector 140 from the portable storage device 200 and return the transmission cable 130 into the main body 410. Thus, the electronic device 400 in the present invention facilitates the transmission of data to and from the portable storage device 200 considerably.

In summary, the electronic device of the preferred embodiment of the present invention has at least the following advantages:
1. The preferred embodiment of the present invention disposes the moveable connector inside the main body (for example, the electronic device) so that the user only has to connect the moveable connector inside the main body with the portable storage device before carrying out the data transmission. Therefore, compared with the conventional technique, the electronic device in the preferred embodiment of the present invention makes the process of transmitting data to and from the portable storage device very convenient.
2. When the electronic device is a PDA, a pocket PC, a tablet PC or other portable electronic device, the user only has to pull out the moveable connector from the main body and connect with the portable storage device before carrying out the data access operation. Therefore, the dimension of the portable storage device will not inconvenience the user in using the device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device suitable for connecting with a portable storage device, the electronic device comprising:
a main body having a display region and an accommodating space;
a protective cover linked to the main body and closed to the accommodating space for covering the accommodating space;
a transmission cable disposed inside the main body such that one end of the transmission cable connects with the main body; and
a moveable connector disposed on another end of the transmission cable, wherein the moveable connector is suitable for connecting with the portable storage device and the accommodating space is suitable for hiding the moveable connector.

2. The electronic device of claim 1, wherein the protective cover is disposed at the edge of the main body.

3. The electronic device of claim 1, wherein the moveable connector is a USB connector.

4. The electronic device of claim 1, wherein the protective cover is hinged to the main body.

5. The electronic device of claim 1, wherein the accommodating space is big enough to hide the portable storage device.

6. The electronic device of claim 1, wherein the electronic device further includes a signal line for connecting to a host computer so that the portable storage device can electrically connect with a host computer through the electronic device and the signal line, and wherein the electronic device is a display device.

7. The electronic device of claim 1, wherein the electronic device is a personal digital assistant (PDA), a pocket PC or a tablet PC.
